(19) United States
(12) Patent Application Publication
(10) Pub. No.: US 2016/0308732 A1
(43) Pub. Date: Oct. 20, 2016

(54) DEVICE MANAGEMENT APPARATUS AND INFORMATION PROCESSING APPARATUS

(71) Applicant: Haruki SAGARA, Tokyo (JP)

(72) Inventor: Haruki SAGARA, Tokyo (JP)

(21) Appl. No.: 15/086,681

(22) Filed: Mar. 31, 2016

(30) Foreign Application Priority Data
Apr. 20, 2015 (JP) 2015-086073

(51) Int. Cl. H04L 12/24

(52) U.S. Cl. CPC H04L 41/20; H04L 41/046

(57) ABSTRACT

A device management apparatus connected to a first communication channel includes a receiver and a manager. The receiver receives device management information, which is for managing a device, transmitted from an information processing apparatus connected to the first communication channel on condition that the information processing apparatus is connected to the device via a second communication channel. The manager manages the received device management information.

### CROSS-REFERENCE TO RELATED APPLICATIONS

The present application claims priority to and incorporates by reference the entire contents of Japanese Patent Application No. 2015-086073 filed in Japan on Apr. 20, 2015.

### BACKGROUND OF THE INVENTION

1. Field of the Invention

The present invention relates generally to device management apparatuses and information processing apparatuses.

2. Description of the Related Art

A device management apparatus configured to manage a device(s) connected to a network over the network is conventionally known. A device management apparatus configured to manage, using an information processing apparatus connected to a network and having agent software installed thereon, a device(s) that is not connected the network but connected to the information processing apparatus via a communication cable or the like over the network is also known. An example of such a device management apparatus is disclosed in Japanese Laid-open Patent Application No. 2013-178744.

However, the conventional technique of managing a device via an information processing apparatus disadvantageously entails cost for creating an environment where the device management apparatus can manage the device.

### SUMMARY OF THE INVENTION

It is an object of the present invention to at least partially solve the problems in the conventional technology.

According to exemplary embodiments of the present invention, there is provided a device management apparatus connected to a first communication channel, the device management apparatus comprising: a receiver configured to receive device management information, the device management information being for managing a device, transmitted from an information processing apparatus connected to the first communication channel on condition that the information processing apparatus is connected to the device via a second communication channel; and a controller configured to manage the received device management information.

Exemplary embodiments of the present invention also provide an information processing apparatus connected to a device management apparatus via a first communication channel, the information processing apparatus comprising: a detector configured to detect that connection with a device via a second communication channel is established; a device information acquirer configured to acquire device information about the device on condition that the detector detects that connection with the device is established; and a transmitter configured to transmit device management information, the device management information being based on the device information, to the device management apparatus.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating an example of a configuration of a device management system of an embodiment of the present invention;

FIG. 2 is a block diagram illustrating an example of hardware components of an information processing apparatus of the present embodiment;

FIG. 3 is a block diagram illustrating an example of hardware components of a device of the present embodiment;

FIG. 4 is a block diagram illustrating an example of hardware components of a device management apparatus of the present embodiment;

FIG. 5 is a block diagram illustrating an example of a functional configuration of the device management system of the present embodiment;

FIG. 6 is a sequence diagram illustrating an example of a process performed by the device management system of the present embodiment when a device is connected; and

FIG. 7 is a sequence diagram illustrating an example of a process performed by the device management system of the present embodiment when the device is disconnected.

### DETAILED DESCRIPTION OF THE PREFERRED EMBODIMENTS

Exemplary embodiments of the present invention are described in detail below with reference to the accompanying drawings.

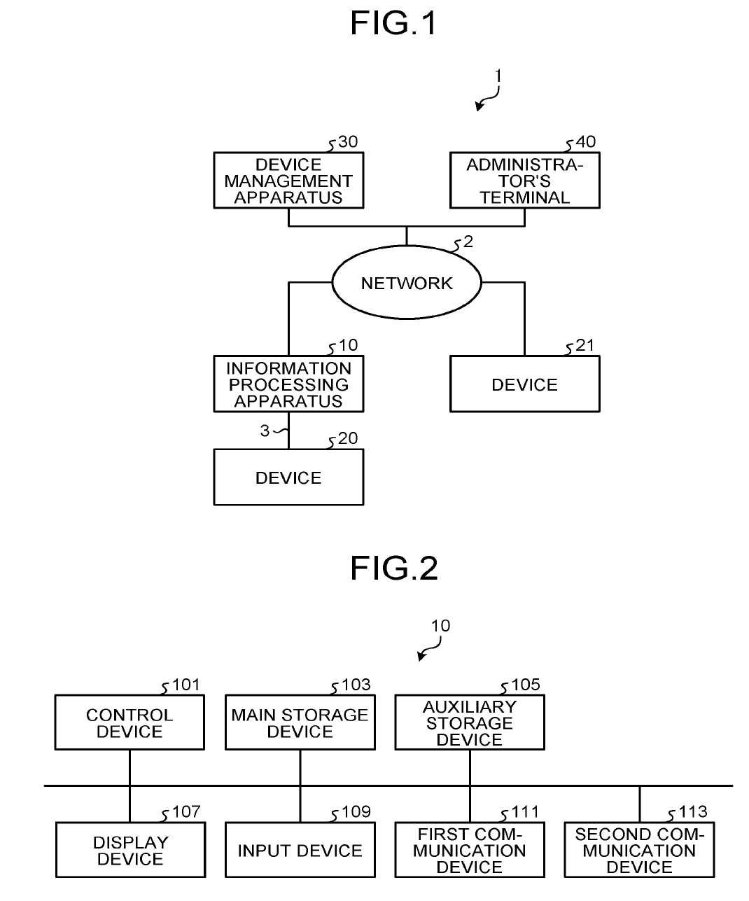

FIG. 1 is a block diagram illustrating an example of a configuration of a device management system 1 of an embodiment of the present invention. As illustrated in FIG. 1, the device management system 1 includes an information processing apparatus 10, devices 20 and 21, a device management apparatus 30, and an administrator's terminal 40.

The information processing apparatus 10, the device 21, the device management apparatus 30, and the administrator's terminal 40 are connected via a network 2 (an example of “first communication channel”). The information processing apparatus 10 and the device 20 are connected via a communication cable 3 (an example of “second communication channel”).

The network 2 can be embodied as a LAN (local area network) or the Internet, for example. The communication cable 3 can be embodied as a USE (universal serial bus) cable, for example.

Any device connectable with the communication cable 3 can be the device 20. Any device connectable to the network 2 can be the device 21. The device 20, 21 may be a device connectable to both the communication cable 3 and the network 2.

Examples of the device 20, 21 include an image forming apparatus, such as a printer, a copier, a multifunction peripheral, a scanner, and a facsimile, electronic equipment of various types, such as a projector, a camera, an air conditioner, a refrigerator, a fluorescent lamp, a vending machine, and a portable hand-held terminal. A multifunction peripheral is an apparatus having at least two of a copier function, a printer function, a scanner function, and a facsimile function. The present embodiment is described through an example where the devices 20 and 21 are printers.

The device management apparatus 30 manages the devices 20 and 21 and can be embodied as a computer, for example. The device management apparatus 30 directly manages the device 21 connected to the network 2 but manages the device 20, which is not connected to the network 2, via the information processing apparatus 10 that is connected to the network 2 and also connected to the device 20 via the communication cable 3. Although FIG. 1 illustrates the devices 20 and 21 as an example of devices to be managed by the device management apparatus 30, the devices to be managed by the device management apparatus 30 are not limited thereto.

Because a known technique can be employed as a method by which the device management apparatus 30 manages the device 21, a method by which the device management apparatus 30 manages the device 20 via the information processing apparatus 10 is described in the present embodiment, but description about the method by which the device management apparatus 30 manages the device 21 is omitted.

The information processing apparatus 10 acts as an agent for the device management apparatus 30 in management of the device 20 and can be embodied as, for example, a PC (personal computer) where agent software, which is described later, is installed (introduced).

The administrator's terminal 40 is a terminal device for an administrator of the device management system 1 and can be embodied as a PC (personal computer), for example. The administrator of the device management system 1 will check (view) device management information managed by the device management apparatus 30 using the administrator's terminal 40.

FIG. 2 is a block diagram illustrating an example of hardware components of the information processing apparatus 10 of the present embodiment. As illustrated in FIG. 2, the information processing apparatus 10 includes a control device 101, such as a CPU (central processing unit) and a GPU (graphics processing unit), a main storage device 103, such as a ROM (read only memory) and a RAM (random access memory), an auxiliary storage device 105, such as an HDD (hard disk drive) and an SSD (solid state drive), a display device 107, such as a liquid crystal display, an input device 109, such as a mouse, a keyboard, and a touch panel, a first communication device 111, which is a communications interface for the network 2, and a second communication device 113, which is a communications interface for the communication cable 3; in short, the information processing apparatus 10 has hardware components implemented on an ordinary computer system. Each of the auxiliary storage device 105, the display device 107, the input device 109, and the first communication device 111 may be either built in or externally connected to the information processing apparatus 10.

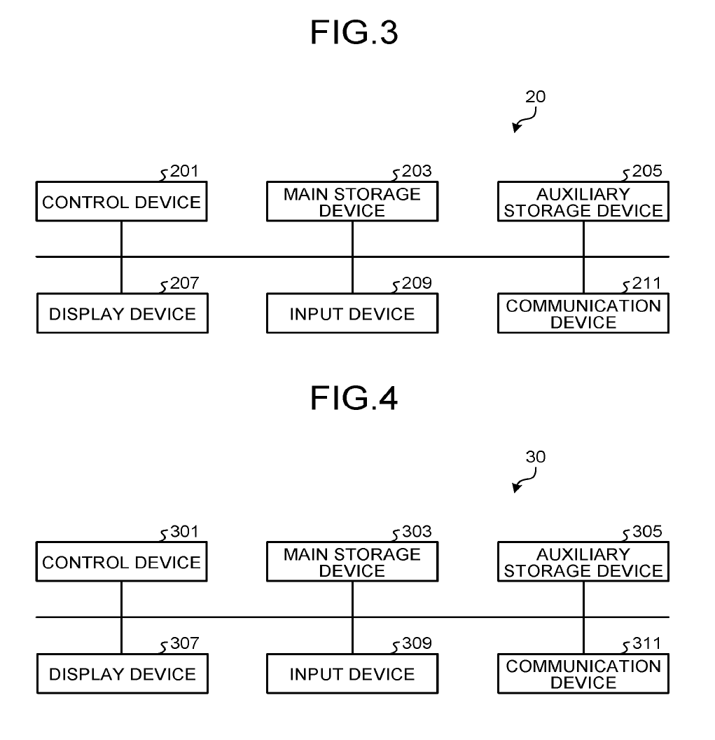

FIG. 3 is a block diagram illustrating an example of hardware components of the device 20 of the present embodiment. As illustrated in FIG. 3, the device 20 includes a control device 201, such as a CPU and a GPU, a main storage device 203, such as a ROM and a RAM, an auxiliary storage device 205, such as an HDD and an SSD, a display device 207, such as a liquid crystal display, an input device 209, such as a key switch and a touch panel, and a communication device 211, which is a communications interface for the communication cable 3; in short, the device 20 has hardware components implemented on an ordinary computer system.

The device 20 may include, in addition to the components described above, hardware components specific to the device, e.g., an IC, an ASIC (application specific integrated circuit), and various sensors.

FIG. 4 is a block diagram illustrating an example of hardware components of the device management apparatus 30 of the present embodiment. As illustrated in FIG. 4, the device management apparatus 30 includes a control device 301, such as a CPU and a GPU, a main storage device 303, such as a ROM and a RAM, an auxiliary storage device 305, such as an HDD and an SSD, a display device 307, such as a liquid crystal display, an input device 309, such as a mouse, a keyboard, and a touch panel, and a communication device 311, which is a communications interface for the network 2; in short, the device management apparatus 30 has hardware components implemented on an ordinary computer system. Each of the auxiliary storage device 305, the display device 307, the input device 309, and the communication device 311 may be either built in or externally connected to the device management apparatus 30.

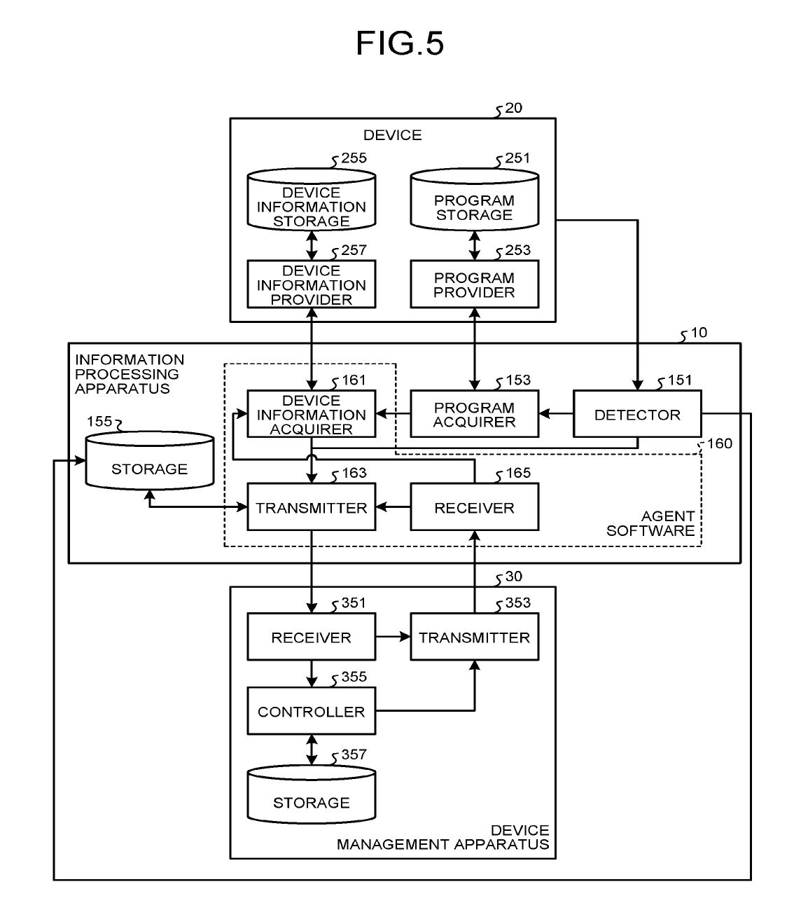

FIG. 5 is a block diagram illustrating an example of a functional configuration of the device management system 1 of the present embodiment. As illustrated in FIG. 5, the information processing apparatus 10 includes a detector 151, a program acquirer 153, a storage 155, and agent software 160 (an example of “software”). The agent software 160 is application software acting as an agent for the device management apparatus 30 in management of a device(s) that is not connected to the network 2. The agent software 160 is installed on the information processing apparatus 10 (i.e., implemented on the information processing apparatus 10) by executing program instructions (hereinafter, “program”) for installing the agent software 160. As illustrated in FIG. 5, the agent software 160 includes a device information acquirer 161, a transmitter 163, and a receiver 165.

The detector 151, the program acquirer 153, and the device information acquirer 161 can be implemented by the control device 101, the main storage device 103, and the second communication device 113, for example. The storage 155 can be implemented by at least any one of the main storage device 103 and the auxiliary storage device 105, for example. The transmitter 163 and the receiver 165 can be implemented by the control device 101, the main storage device 103, and the first communication device 111, for example.

As illustrated in FIG. 5, the device 20 includes a program storage 251, a program provider 253, a device information storage 255, and a device information provider 257.

The program storage 251 and the device information storage 255 can be implemented by at least any one of the main storage device 203 and the auxiliary storage device 205, for example. The program provider 253 and the device information provider 257 can be implemented by the control device 201, the main storage device 203, and the communication device 211, for example.

As illustrated in FIG. 5, the device management apparatus 30 includes a receiver 351, a transmitter 353, a controller 355, and a storage 357. The receiver 351, the transmitter 353, and the controller 355 function as a manager of the agent software 160 of the information processing apparatus 10.

The receiver 351 and the transmitter 353 can be implemented by the control device 301, the main storage device 303, and the communication device 311, for example. The controller 355 can be implemented by the control device 301 and the main storage device 303, for example. The storage 357 can be implemented by at least any one of the main storage device 303 and the auxiliary storage device 305, for example.

The storage 155 stores an IP address, a MAC address, or the like of the information processing apparatus 10. The present embodiment is described through an example where the IP address is used as information-processing-apparatus identification information, by which the information processing apparatus 10 is identified. However, the information-processing-apparatus identification information is not limited thereto, and can be any information, e.g., the MAC address, by which the information processing apparatus 10 can be identified.

The detector 151 detects that connection with the device 20 via the communication cable 3 is established. This detection function of the detector 151 can be implemented using a function (e.g., a function of recognizing a peripheral device) provided by an OS (operating system) installed on the information processing apparatus 10, for example.

Upon detecting that connection with the device 20 via the communication cable 3 is established, the detector 151 stores (registers) a port number of a port, where the communication cable 3 is connected, of the information processing apparatus 10 in the storage 155.

On condition that the detector 151 detects that connection with the device 20 is established, the program acquirer 153 acquires a program for installing the agent software 160 from the device and causes the agent software 160 to be installed on the information processing apparatus 10 by using the program.

Specifically, on condition that the detector 151 detects that connection with the device 20 is established, the program acquirer 153 determines whether or not the agent software 160 is installed on the information processing apparatus 10. If the agent software 160 is not installed, the program acquirer 153 submits, to the device 20, a request for the program for installing the agent software 160 and acquires the program provided by the device 20. The program acquirer 153 executes (starts) an installer contained in the acquired program, thereby causing the installer to install the agent software 160 contained in the acquired program on the information processing apparatus 10. The device information acquirer 161, the transmitter 163, and the receiver 165 are thus implemented on the information processing apparatus 10.

The above-described functions of the program acquirer 153 can be implemented using a function (e.g., a plug-and-play feature) provided by the OS (operating system) installed on the information processing apparatus 10, for example. If the agent software 160 is already installed on the information processing apparatus 10, the program acquirer 153 does not perform submitting a request for the program for installing the agent software 160 and the following installing step.

The program storage 251 stores the program for installing the agent software 160. Upon receiving the request requesting for the program for installing the agent software 160 from the information processing apparatus 10, the program acquirer 253 retrieves the program from the program storage 251 and provides the program to the information processing apparatus 10.

On condition that the detector 151 detects that connection with the device 20 is established, the device information acquirer 161 acquires device information about the device 20 from the device 20. Specifically, on condition that the detector 151 detects that connection with the device 20 is established and that the agent software 160 is installed on the information processing apparatus 10, the device information acquirer 161 submits a request for device information to the device 20 and acquires the device information about the device 20 provided by the device 20.

If the agent software 160 is already installed on the information processing apparatus 10 when the detector 151 detects that connection with the device 20 is established, the device information acquirer 161 acquires the device information about the device 20 from the device 20 on the basis that the detector 151 detects that connection with the device 20 is established.

The device information can be any information concerning the device 20. Examples of the device information include, but are not limited to, a serial number, an IP address, a MAC (media access control) address, status information, and a value of a counter. The present embodiment is described through an example where device identification information such as a serial number by which the device 20 is identified is used as the device information. However, the device information is not limited to the device identification information. And, the device identification information is not limited to the serial number, and may be any information, e.g., the IP address or the MAC address, by which the device 20 can be identified.

The device information storage 255 stores the device information about the device 20. Upon receiving a request for the device information about the device 20 from the information processing apparatus 10, the device information provider 257 retrieves the device information from the device information storage 255 and provides the device information to the information processing apparatus 10.

The transmitter 163 transmits device management information, which is based on the device information about the device 20 acquired by the device information acquirer 161, about the device 20 to the device management apparatus 30. Specifically, the transmitter 163 transmits the device management information about the device 20 to the device management apparatus 30 using the IP address of the device management apparatus 30.

The IP address of the device management apparatus 30 may be acquired by using either a scheme of storing the IP address in the storage 155 in advance or a scheme where the transmitter 163 acquires the IP address by searching for the device management apparatus 30 on the network 2. The latter scheme can be carried out as follows, for example. The transmitter 163 broadcasts a packet to addresses in the same network segment as the information processing apparatus 10, and the receiver 165 receives a response packet. The packet to be broadcasted is a packet requesting the device management apparatus 30 to return a response. Examples of the packet include a packet designating the device management apparatus 30 by its serial number. The transmitter 163 can thus acquire the IP address of the device management apparatus 30 as an IP address of a sender (source) of the response packet received by the receiver 165.

The transmitter 163 generates device management information by adding information about the information processing apparatus 10 acting as an agent for the device management apparatus 30 in management of the device 20 to the device information about the device 20 acquired by the device information acquirer 161. Specifically, the transmitter 163 generates device management information by retrieving the IP address of the information processing apparatus 10 and the port number of the port where the communication cable 3 is connected from the storage 155 and adding the IP address and the port number to the device information about the device 20 acquired by the device information acquirer 161.

The present embodiment is described through an example where the port number is used as connection status information indicating a connection status between the information processing apparatus 10 and the device 20. However, the connection status information is not limited thereto, and can be any information indicating the connection status between the information processing apparatus 10 and the device 20. In the present embodiment, upon detecting that connection with the device 20 via the communication cable 3 is broken, the detector 151 deletes the port number of the port, where the communication cable 3 is connected, of the information processing apparatus 10 from the storage 155. Hence, it is indicated that, so long as the port number is contained in the device management information, the information processing apparatus 10 is connected to the device 20.

The receiver 351 receives the broadcasted packet. The receiver 351 also receives the device management information for managing the device 20 transmitted from the information processing apparatus 10.

When the broadcasted packet is received by the receiver 351, the transmitter 353 transmits, to the sender (source) of the packet, a response packet.

The controller 355 manages the device management information received by the receiver 351 on the storage 357. Specifically, the controller 355 makes a determination as to whether or not device management information containing a serial number matching the serial number (the device identification information) of the device 20 contained in the device management information received by the receiver 351 is managed on the storage 357.

If the determination is negative, the controller 355 starts managing the received device management information on the storage 357. If the determination is positive, the controller 355 integrates the received device management information into the device management information managed on the storage 357 and manages the integrated device management information.

After starting managing the device management information about the device 20, the controller 355 acquires device management information from the device 20 at regular intervals, integrates the acquired device management information into the device management information managed on the storage 357, and manages the integrated device management information. Specifically, under direction of the controller 355, the transmitter 353 submits a request for device management information about the device 20 to the information processing apparatus 10. When the request is received by the receiver 165 of the information processing apparatus 10, the device information acquirer 161 acquires device information about the device 20 from the device 20. The transmitter 163 generates device management information by adding information about the information processing apparatus 10 to the device information about the device 20 acquired by the device information acquirer 161 and transmits the device management information to the device management apparatus 30. When the device management information is received by the receiver 351 of the device management apparatus 30, the controller 355 integrates the received device management information into the device management information managed on the storage 357 and manages the integrated device management information.

Furthermore, the receiver 351 receives a request for viewing the device management information from the administrator's terminal 40. When the view request is received by the receiver 351, the controller 355 retrieves the device management information from the storage 357 and generates screen data for use in viewing. The transmitter 353 transmits the screen data for use in viewing generated by the controller 355 to the administrator's terminal 40. Hence, the screen data use in viewing is displayed on a display or the like of the administrator's terminal 40, so that the administrator of the device management system 1 views the device management information.

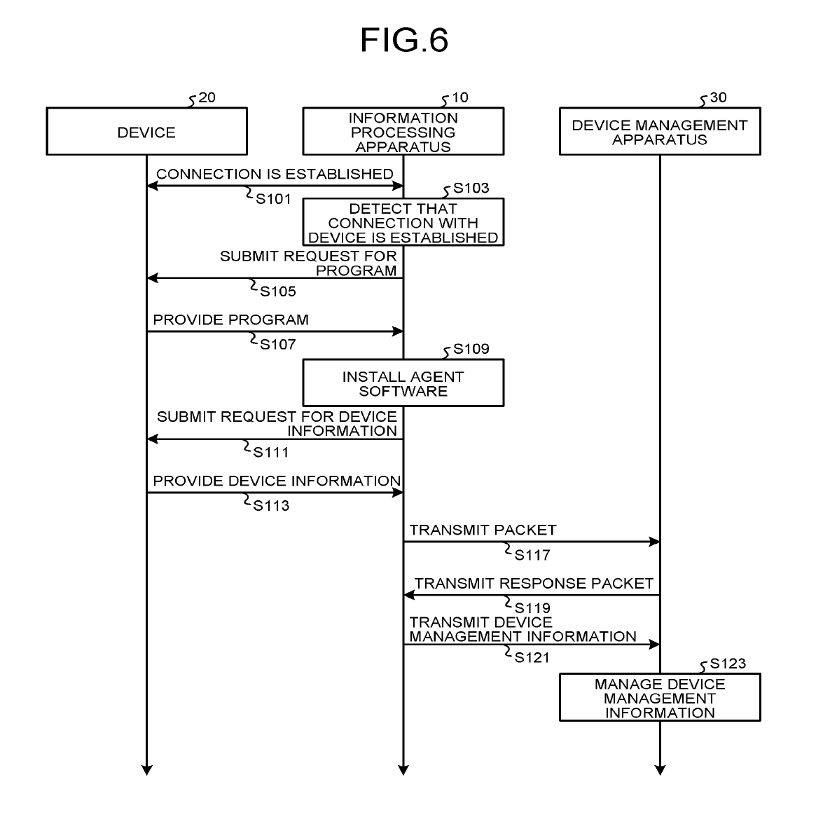

FIG. 6 is a sequence diagram illustrating an example of a process performed by the device management system 1 of the present embodiment when a device is connected.

When connection between the information processing apparatus 10 and the device 20 via the communication cable 3 is established (step S101), the detector 151 detects that connection with the device 20 via the communication cable 3 is established (step S103). The detector 151 stores (registers) a port number of a port, where the communication cable 3 is connected, of the information processing apparatus 10 in the storage 155.

Thereafter, on the basis that the detector 151 detects that connection with the device 20 is established, the program acquirer 153 determines whether or not the agent software 160 is installed on the information processing apparatus 10. If the agent software 160 is not installed, the program acquirer 153 submits, to the device 20, a request for the program for installing the agent software 160 (step S105) and acquires the program provided by the device 20 (step S107).

Thereafter, the program acquirer 153 executes (starts) an installer contained in the acquired program, thereby causing the installer to install the agent software 160 on the information processing apparatus 10 (step S109).

Thereafter, on condition that the agent software 160 is installed on the information processing apparatus 10, the device information acquirer 161 submits a request for device information to the device 20 (step S111) and acquires device information about the device 20 provided by the device 20 (step S113).

If the agent software 160 is already installed on the information processing apparatus 10, processing of steps S105 through S109 is not performed but, on the basis that the detector 151 detects that connection with the device 20 is established, processing of step S111 is performed.

Thereafter, the transmitter 163 broadcasts a packet to addresses in the same network segment as the information processing apparatus 10 (step S117). The receiver 165 receives a response packet (step S119).

Thereafter, the transmitter 163 generates device management information about the device 20 by retrieving the IP address of the information processing apparatus 10 and a port number of a port where the communication cable 3 is connected from the storage 155 and adding the IP address and the port number to the device information about the device 20 acquired by the device information acquirer 161. The transmitter 163 transmits the device management information about the device 20 to the device management apparatus 30 by using an IP address of the sender (source) of the response packet received by the receiver 165 as the IP address of the device management apparatus 30 (step S121).

The receiver 351 receives the device management information about the device 20 from the information processing apparatus 10. The controller 355 makes a determination as to whether or not device management information containing a serial number matching the serial number (the device identification information) of the device 20 contained in the device management information received by the receiver 351 is managed on the storage 357. If the determination is negative, the controller 355 registers the received device management information in the storage 357 and starts managing the device management information. If the determination is positive, the controller 355 integrates the received device management information into the device management information managed on the storage 357 and manages the integrated device management information (step S123).

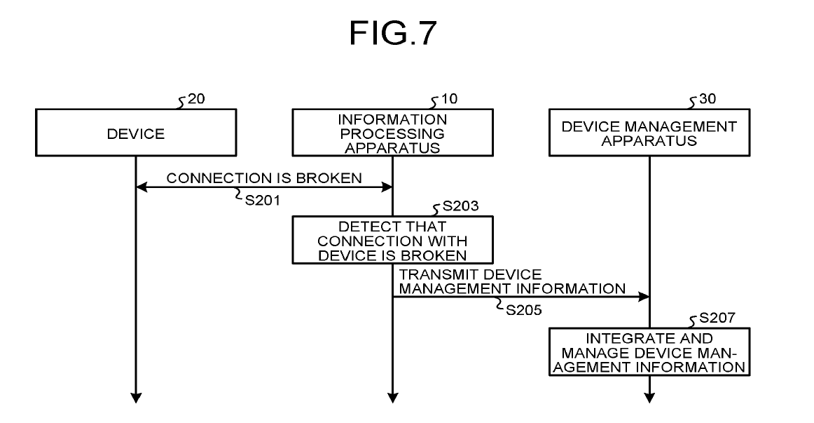

FIG. 7 is a sequence diagram illustrating an example of a process performed by the device management system 1 of the present embodiment when the device is disconnected.

When connection between the information processing apparatus 10 and the device 20 via the communication cable 3 is broken (step S201), the detector 151 detects that connection with the device 20 via the communication cable 3 is broken (step S203). The detector 151 deletes the port number of the port, where the communication cable 3 has been connected, of the information processing apparatus 10 from the storage 155.

Thereafter, the transmitter 163 generates device management information about the device 20 by retrieving the IP address of the information processing apparatus 10 from the storage 155 and adding the IP address to the serial number (the device identification information), which is already acquired by the device information acquirer 161, of the device 20. The transmitter 163 transmits the device management information about the device 20 to the device management apparatus 30 using the IP address of the device management apparatus 30 (step S205).

The receiver 351 receives the device management information about the device 20 from the information processing apparatus 10. The controller 355 searches the storage 357 for device management information containing a serial number matching the serial number (the device identification information) of the device 20 contained in the device management information received by the receiver 351, integrates the received device management information into the found device management information, and manages the integrated device management information (step S207). Because the latest device management information about the device 20 stored in the storage 357 contains no port number, management can be carried on the basis that connection between the information processing apparatus 10 and the device 20 is broken.

As described above, in the present embodiment, when the device 20 to be managed by the device management apparatus 30 is connected to the information processing apparatus 10, device management information about the device 20 is autonomously transmitted from the information processing apparatus 10 to the device management apparatus 30.

Therefore, according to the present embodiment, when the device 20 is connected to the information processing apparatus 10, the device management apparatus 30 can automatically manage device management information about the device 20. Accordingly, because cost in terms of time entailed in creating an environment where the device management apparatus 30 can manage the device 20 can be reduced, cost entailed in creating the environment where the device management apparatus 30 can manage the device 20 can be reduced.

A method of managing the device 20 by searching, by the device management apparatus 30, for the information processing apparatus 10 where the device 20 to be managed by the device management apparatus 30 is connected at regular intervals and, when the information processing apparatus 10 is found, acquiring device management information about the device 20 from the information processing apparatus 10 disadvantageously entails cost in terms of time from when the device 20 is connected to the information processing apparatus 10 until when an environment where the device management apparatus 30 can manage the device 20 is created.

In particular, in a situation where the number of devices to be managed by the device management apparatus 30 is large and management of the large number of devices is to be started simultaneously, cost in terms of time entailed in creating an environment where the device management apparatus 30 can manage these devices is considerably large, which is disadvantageous.

However, in the present embodiment, if the agent software 160 is not installed on the information processing apparatus 10 when the device 20 to be managed by the device management apparatus 30 is connected to the information processing apparatus 10, the agent software 160 is automatically installed on the information processing apparatus 10.

Thus, according to the present embodiment, because the need of manually installing the agent software 160 on the information processing apparatus 10 is eliminated, cost in terms of manpower entailed in creating an environment where the device management apparatus 30 can manage the device 20 can be reduced. As a result, cost entailed in creating the environment where the device management apparatus 30 can manage the device 20 can be reduced.

In a situation where the number of devices to be managed by the device management apparatus 30 is large and it is required to manually install the agent software 160 on the large number of devices, cost in terms of manpower entailed in creating an environment where the device management apparatus 30 can manage these devices is disadvantageously considerably large.

According to an aspect of the present invention, cost entailed in creating an environment where a device management apparatus can manage a device via an information processing apparatus can be reduced.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A device management apparatus connected to a first communication channel, the device management apparatus comprising:
a receiver configured to receive device management information, the device management information being for managing a device, transmitted from an information processing apparatus connected to the first communication channel on condition that the information processing apparatus is connected to the device via a second communication channel; and
a controller configured to manage the received device management information.

2. The device management apparatus according to claim 1, wherein
if software acting as an agent in management of the device is not introduced to the information processing apparatus, the receiver receives the device management information transmitted from the information processing apparatus on condition that the software is introduced to the information processing apparatus.

3. The device management apparatus according to claim 1, wherein
the device management information is information based on device information about the device, the device information being acquired by the information processing apparatus from the device.

4. The device management apparatus according to claim 1, wherein
the device management information contains at least device identification information, by which the device is identified, and
the controller makes a determination as to whether device management information containing device identification information matching the device identification information contained in the received device management information is being managed by the controller and, if the determination is negative, starts managing the received device management information.

5. The device management apparatus according to claim 4, wherein
if device management information containing device identification information matching the device identification information contained in the received device management information is being managed by the controller, the controller integrates the received device management information into the device management information managed by the controller and manages the integrated device management information.

6. The device management apparatus according to claim 1, wherein
the device management information contains information-processing-apparatus identification information, by which the information processing apparatus is identified, and connection status information indicating a connection status between the information processing apparatus and the device.

7. An information processing apparatus connected to a device management apparatus via a first communication channel, the information processing apparatus comprising:
a detector configured to detect that connection with a device via a second communication channel is established;
a device information acquirer configured to acquire device information about the device on condition that the detector detects that connection with the device is established; and
a transmitter configured to transmit device management information, the device management information being based on the device information, to the device management apparatus.

8. The information processing apparatus according to claim 7, further comprising
a program acquirer configured to, if software acting as an agent in management of the device is not introduced to the information processing apparatus, on condition that the detector detects that connection with the device is established, acquire a program for introducing the software from the device and cause the software to be introduced to the information processing apparatus by using the program, wherein
the device information acquirer acquires the device information on condition that the software is introduced.

9. The information processing apparatus according to claim 7, wherein
the transmitter performs a search for the device management apparatus and transmits the device management information to the device management apparatus found by the search.
